(19) United States
(12) Patent Application Publication
(10) Pub. No.: US 2010/0327823 A1
(43) Pub. Date: Dec. 30, 2010

(54) REACTIVE POWER COMPENSATION CIRCUIT

(76) Inventor: Pol Nisenblat, Burnside (AU)

Correspondence Address: YORAM TSIVION, P.O. BOX 1307, PARDES HANNA, 37111, IL

(21) Appl. No.: 12/865,129

(22) PCT Filed: Feb. 25, 2009
(86) PCT No.: PCT/IB09/50746

§ 371 Date: Jul. 29, 2010

(30) Foreign Application Priority Data
Feb. 25, 2008 (GB) 0803261.7

(51) Int. Cl. G05F 1/70

(52) U.S. Cl. 323/206

(57) ABSTRACT

A compensation circuitry for providing reactive power to a network includes an inductance means and a capacitor means associated with switching appliances and with a controlling mechanism. The compensation circuitry is used for delivering reactive power compensation to electrical networks of either low or high voltage. The inductance means and the capacitor means are connected serially, thereby bringing the circuitry to a virtual gain selected from a group consisting of virtual inductance gain (VIG) or virtual capacitance gain (VCG), and wherein the virtual gain selected from the group is above the absolute value of 1.5.

### FIELD OF THE INVENTION

The present invention is in the field of reactive power. More specifically, the present invention relates to reactive power compensation.

### BACKGROUND OF THE INVENTION

Reactive power is the power used by some devices to create an electromagnetic field. This power is expressed in kvar. The consumption of reactive power is a characteristic of electric devices which use the inductive properties of an alternating electromagnetic field, i.e. mostly motors and transformers. Reactive power is different from active power, expressed in kW, which is converted into work and heat. The total electrical power of a device is the vector difference of both power components (reactive and active) and is called apparent power. This phenomenon of reactive power may have consequences for electrical networks of both low and high voltage. Devices which store energy by virtue of a magnetic field produced by a flow of current are said to absorb reactive power; those which store energy by virtue of electric fields are said to generate reactive power. Power flows, both active and reactive, must be carefully controlled in order for a power system to operate within acceptable voltage limits. Reactive power flows can give rise to substantial voltage changes across the system, meaning that it is necessary to maintain reactive power balances. Reactive power compensation is an essential feature in a power system's operation and maintenance of acceptable voltage levels during contingences in power systems. There are many solutions known in the art for compensating for the reactive power of the load connected to a power system. Some examples of such solutions are described infra.

The simplest solution is a combination of passive elements, i.e. shunt capacitors and inductors. A second solution is using electromechanically switched, tuned or detuned capacitor banks to cope with load changes. A third solution uses static voltage ampere reactive (VAR) compensation techniques providing rapid accurate reactive power control based on electronic switching of plurality of passive components such as tuned or detuned capacitors banks and/or one or more inductors branches. A static VAR compensator is typically based on thyristor control reactors (TCR), thyristor switched capacitors (TSC), and/or fixed capacitors tuned to filters. In some applications, the static VAR compensator (SVC) can be simplified to plurality of TSC based branches only. A schematic description of typical TSC branch is described in FIG. 1 to which reference is now made. TSC branch 20 includes one or more capacitors 22 connected in a series with switching means such as thyristor 24 and one or more inductors 26. The inductor is used to limit the inrush current and/or harmonic detuning/tuning. Inrush current refers to the maximum, instantaneous input current drawn by an electrical device when first turned on. The size of the inductor is designed to protect capacitors and the network from possible parallel resonance conditions between the capacitors and transmission network at some of the harmonic current frequencies. A main disadvantage of SVC is that it provides reactive power proportional to the second power of the voltage (V²). This means that reactive power supply is substantially decreased at low voltages. At normal network operation conditions when network voltage varies within a range of ±10% that disadvantage is insignificant. However, in some applications, such as large load variations such as an AC motor start-up or grid fault conditions, voltage may drop to levels significantly lower than defined as normal or steady state voltages. The problem is that during such extraordinary conditions the network's demand for the reactive energy is vital, and inability for or limitations on immediate response with required reactive current may destabilize systems.

Another use of combination of reactive passive elements is for coping with harmonic pollution. Power electronic devices such as power converters, power supplies, converter-fed motors and sometimes the power compensation circuit itself such as static var compensator (SVC), causes harmonic pollution. This kind of pollution is a strong distortion of the fundamental sinusoidal wave shape of voltage and current. The Fourier analysis of a fundamental period reveals the presence of typical harmonic frequencies which are usually multiples of the 50 Hz fundamental frequency. The major distortion is normally caused by power converters and other power electronics which to a large extent generate 250, 350, 550, 650 Hz and higher frequency (HF) harmonics. There are many solutions known in the art for coping with harmonic pollution, some examples of such solutions are described infra.

In one example detuned reactors are installed in series with the capacitors and prevent resonance conditions by shifting the capacitor/network resonance frequency below the first dominant harmonic (usually the 5^{th}). In another example, if harmonic filtration is needed, in addition to resonance prevention, tuned reactors are applied. The capacitor/reactor filter is tuned to absorb and reduce the total harmonic distortion (THD).

It should be noted that in all of the implementations discussed above (inrush current limiting, detuned and tuned), the inductor and capacitor passive elements are used such that the reactance X_{L} in the fundamental frequency varies in ranges from almost 0% to 14% of the capacitor reactance X_{C} in the fundamental frequency.

### BRIEF DESCRIPTION OF THE DRAWINGS

FIG. 1 is a schematic description of an electricity branch including typical thyristor switched capacitors;

FIG. 2 is a schematic description of a power compensation circuitry employed in accordance with the present invention;

FIG. 3 is a schematic description of a controlled power compensation circuitry of a single phase AC current employed in accordance with the present invention;

FIG. 4 is a schematic graph showing changes in inductance as a function of increases voltage;

FIG. 5 is a flow chart describing a procedure for compensating for reactive power in accordance with the present invention;

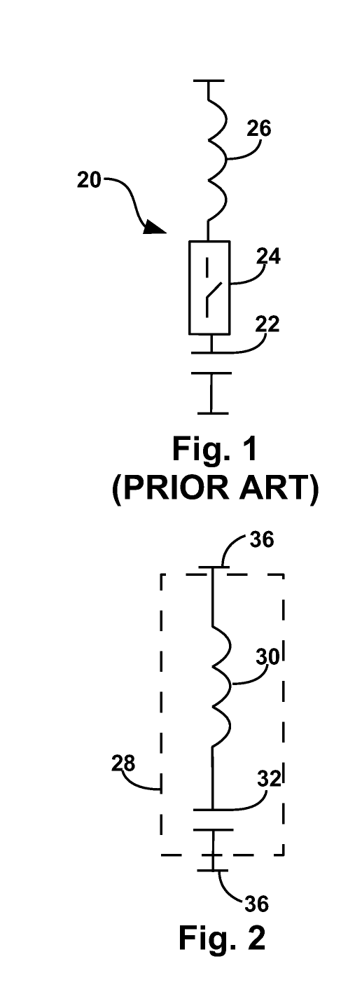

### DETAILED DESCRIPTION OF THE PRESENT INVENTION

In accordance with the present invention appliances for absorbing reactive power such as inductors and appliances for generating reactive power such as capacitors are associated with switching appliances and with a controlling mechanism for delivering reactive power compensation to electrical networks of either low or high voltage. A schematic description of a power compensation branch circuitry employed in accordance with the present invention is described in FIG. 2 to which reference is now made. Power compensation branch 28 includes inductor 30 and capacitor 32. A relationship between I, V and X in the branch is given by equation 1 as follows:

$$I = \frac{V}{{X}_{C} - {X}_{L}} \qquad ( 1 )$$

Where V is the voltage across branch 28, X_{L} is the inductor reactance in the fundamental frequency and X_{C} is the capacitor reactance in the fundamental frequency. In accordance with one embodiment of the present invention the resulting impedance of the branch in the overall is a capacitive one.

In order to better explain the function of a branch in accordance with one aspect of the invention, a new entity is defined hereinafter referred to as virtual capacitance gain (VCG) in absolute values. The definition is given by equation 2:

$$VCG = \vert \frac{I}{{I}_{( {X}_{L} / {X}_{C} = 0 )}} \vert where {X}_{L} \leq {X}_{C} \qquad ( 2 )$$

Where, I is the current that flows through branch 28, with different inductor reactance values. The current I_{(X}_{_{L}}_{/X}_{_{C}}₌₀₎ is defined as the current that flows through branch 28, while the branch is set with an inductor reactance zero. In both settings the same voltage is fed to branch 28.

Table 1 below lists examples of simulated results of an electrical circuitry like branch 28. The circuitry receives a supplied of 50V with a fundamental frequency of 50 Hz. The current that flows through branch 28 can be increased depending on the combined values of inductor 30 and capacitor 32, such that the resulting impedance in the overall is a capacitive one.

TABLE 1
Virtual capacitance gain - VCG, different X_{L} values which are used with fixed
capacitors of 1263 μF 120 kVAr, 550 v/50 Hz at Voltage level of 50 V

| L [mH] | (X_{L}/X_{C}) * 100 [%] | I [Amp] | VCG | Comments |
|---|---|---|---|---|
| 0.00 | 0 | 19.8 | 1.00 | Ranges of X_{L} values used in prior |
| 0.562 | 7 | 21.3 | 1.08 | art applications uses passive |
| 1.123 | 14 | 23.1 | 1.17 | elements of inductors and |
| | | | | capacitors connected serially. |
| 3.21 | 40 | 33.1 | 1.67 | Significant virtual |
| 4.012 | 50 | 39.7 | 2.00 | capacitance gain (VCG) |
| 4.814 | 60 | 49.6 | 2.50 | due to the use of different |
| 5.617 | 70 | 66.1 | 3.34 | X_{L} values. |
| 6.419 | 80 | 99.2 | 5.01 | |
| 7.222 | 90 | 198 | 10.00 | |
| 7.543 | 94 | 330 | 16.66 | |
| 7.703 | 96 | 496 | 25.05 | |
| 7.864 | 98 | 992 | 50.10 | |
| 8.024 | 100 | Infinity* | Infinity* | |

*Very high values which are limited by resistance impedance of the inductor and the capacitance.

The first column on the left shows values of inductance L in an increasing order. The next column shows percentage of reactance X_{L} in respect to X_{C}. The third column from the left shows the current value that flows through branch 28 in respect of each pair of X_{L} and X_{C}. The fourth column shows the ratio between the current value through branch 28 and a reference current value where X_{L} is set to 0% of X_{C}. The reference current I_{(X}_{_{L}}_{/X}_{_{C}}₌₀₎ value is equal to 19.8 Amp. The simulation results show that as the inductor reactance value nears the capacitor reactance, the VCG rises.

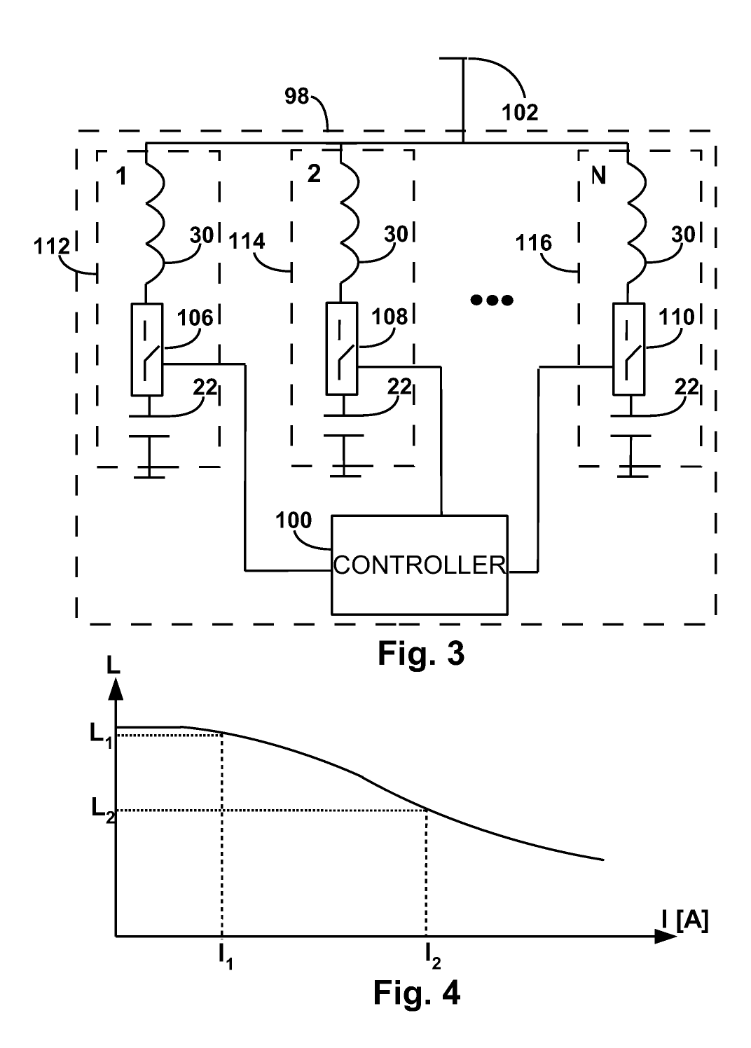

A schematic description of a reactive power compensation circuitry of a single phase AC current employed in accordance with the present invention is described in FIG. 3 to which reference is now made. Reactive power compensation circuitry 98 includes controller mechanism 100 which may be implemented in hardware and/or in software run by a processor. Controller mechanism 100 is used to monitor the parameters of the grid network such as voltage level of power network 102 while making the logical decision of when to turn switches 106,108,110 on or off. Switching appliances 106,108,110 enable the placement of one or more power compensation branches 112,114,116 respectively in and out of the power network. The switching appliances preferably consist of silicon controlled rectifiers (SCR's). Once the control mechanism has detected a need for a reactive compensation for example by detecting a significant voltage drop in power network 102, the control mechanism switches one or more compensation branches 112,114,116 on, meaning, reactive power is fed into the power network. Preferably, the compensation branches have a VCG higher then 1.5. The VCG yields a relatively high reactive current providing a temporary reactive energy compensation which assists the network to raise the voltage rapidly and reach its required value. This reduces the negative effects on valuable electrical components sensitive to voltage dropdown or other unfavourable electrical network conditions. Once the desirable level of network voltage is achieved or some time elapses from the point of turning on the switching means, the controlling mechanism will switch off one or more Switching appliances 106,108,110.

While the network operates under normal conditions e.g., when the voltage network is above 80% of the nominal voltage, the voltage booster circuitry (VBC) of the invention is kept switched off and thus has no effect on the electrical network. Once controlling mechanism has detected a network voltage drop, for example bellow 80% of the nominal voltage, the controller switches one or more of the electrical switch components on. The controller continues to monitor the power network and when it detects that voltage has risen, for example to above 80% of the nominal voltage, the controller will switch the electrical switch component off. During the voltage rise in the network, the controller can switch off or on each of electrical switching components 106, 108 and 110.

It should be noted that the controlled power compensation circuitry implemented in accordance with the present invention may be installed in any place along the route of the electric power transmission which is generated by the power generator, not shown. For example it may be installed along some point in the grid network or near reactive power consumers. It should be also noted that the controlled power compensation circuitry implemented in accordance with the present invention may be implemented in power network systems having more than one AC current phases including connections between two phases and phase to neutral line. Each of the AC current phases generated by a power generator, not shown, may be connected to more than one branch built in accordance with the present invention such as branches 106, 108 and 110. More than one controller mechanism may be used for controlling one or more branches in each AC current phase implemented in accordance with the present invention, such as branches 106, 108 and 110.

In another aspect of the present invention control mechanism 100 also controls the temperature of absorbing reactive power elements 112, 114 and 116. Due to the fact that a massive reactive current might be flowing through absorbing reactive power elements 112, 114 and 116, possibly increasing the heat of the absorbing reactive power elements there is need for a protection mechanism. Therefore, the controller mechanism based on the voltage and/or current measured and/or alternatively based on temperature sensing, can switch the circuitry off, for example after a few seconds of operation.

In another aspect of the present invention the controller feeds one or more inductors of the branches a direct current (D.C.) voltage for reducing inductor value.

In another embodiment of the present invention a hysteresis function implemented in hardware or software can be applied in the controlling mechanism to eliminate unnecessary switching on or off which may occur due to short time voltage drop or rise.

In some embodiments of the present invention one or more reactive power elements 112, 114 and 116 are applied such that at a low current, the inductors are relatively higher than the value of inductor L in a higher current. A graph that shows an example of inductance change as a function of increase in current is described in FIG. 4 to which reference is now made. Considering the case in which the reactive power element of a branch is made such that the inductor's nominal current is near its saturation level and the voltage of the network is low with respect to the nominal voltage, and, the value of the inductor in the branch is L₁. When the network voltage rises, and consequently the current is higher, the value of the inductor decreases from L₁ to L₂ i.e. L₂<L₁. As a result of a decrease in the inductance, the reactance of the inductor decreases too and thus the total reactance in the branch increases.

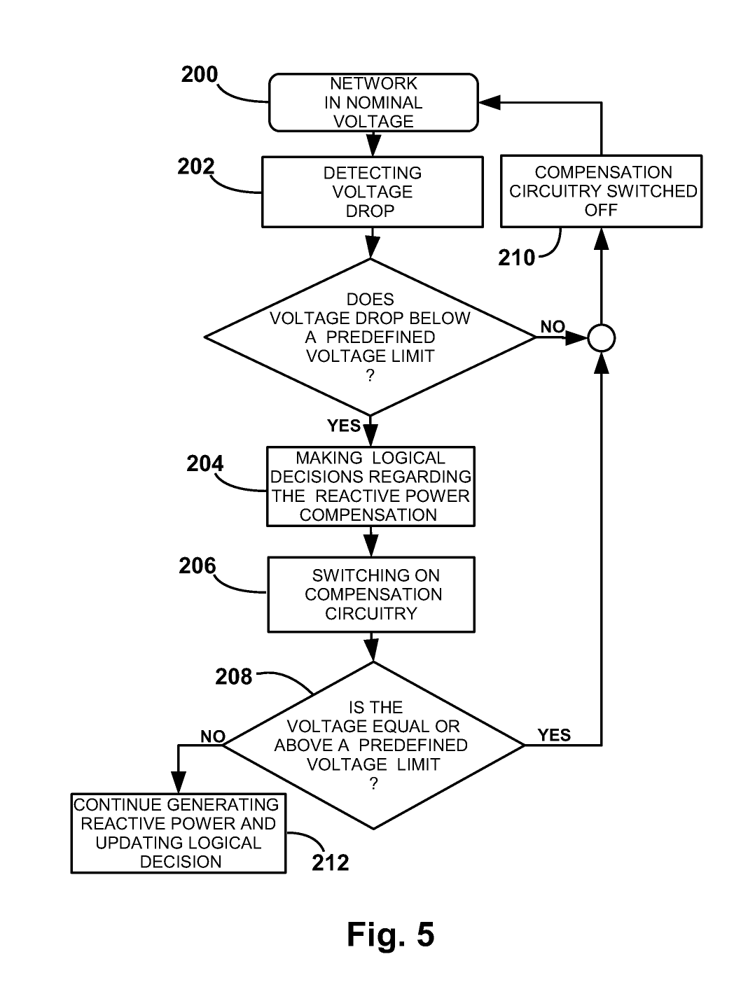

A flow chart describing the process of reactive power compensation is described in FIG. 5 to which reference is now made. At step 200 the electrical network operates in its nominal values. At step 202 a network drop/fault occurs and a network drop/fault is detected. If the network voltage drops below a predefined limit, a logical decision is made at step 204 regarding the reactive power compensation. At step 206 one or more reactive power elements are switched on. If the voltage network is equal to or above a predefined voltage limit, a decision is made by the controller at step 208 that one or more compensation circuitries are switched off at step 210. If the voltage network is equal or below a predefined voltage, reactive power continues to be generated and the logical decisions are updated in step 212. The controller can make a decision based on other sensing parameters of the grid network such as power factor, grid code ride through requirements or any combination thereof.

It should be noted that some steps of the above described process can be combined, executed repeatedly, omitted and/or rearranged.

Referring again to FIG. 2, in accordance with another embodiment of the present invention the resulting impedance of branch 28 in the overall is an inductive one. In order to better explain the function of a branch of the invention, a new entity is defined, hereinafter referred to as virtual inductance gain (VIG) in absolute values. The definition is given by equation 3:

$$VIG = \vert \frac{I}{{I}_{( {X}_{L} / {X}_{C} = 0 )}} \vert where {X}_{C} \leq {X}_{L}$$

I, is the current that flows through branch 28 with different capacitor reactance values. The current I_{(X}_{_{L}}_{/X}_{_{C}}₌₀₎ is defined as the current that flows through branch 28, while the branch is set with an inductor reactance zero. In both settings the same voltage is fed to branch 28.
Table 2 below lists examples of simulated results of an electrical circuitry like branch 28. The circuitry receives a supplied of 50V with a fundamental frequency of 50 Hz. The current that flows through branch 28 can be increased depending on the combined values of inductor 30 and capacitor 32, such that the resulting impedance in the overall is an inductive one.

TABLE 2
Virtual inductive gain - VIG, different X_{L} values which
are used with fixed capacitors of 1263 μF 120 kVAr,
550 v/50 Hz at Voltage level of 50 V

| L [mH] | (X_{L}/X_{C}) * 100 [%] | I [Amp] | VIG | Comments |
|---|---|---|---|---|
| 8.024 | 100 | Infinity | Infinity | Significant virtual |
| 8.185 | 102 | −992 | 50.1 | capacitance gain (VIG) |
| 8.345 | 104 | −496 | 25.05 | due to the use of |
| 8.506 | 106 | −330 | 16.66 | different X_{L} values. |
| 8.826 | 110 | −198 | 10.00 | |
| 9.629 | 120 | −99.2 | 5.01 | |
| 11.23 | 140 | −49.6 | 2.50 | |
| 12.04 | 150 | −39.7 | 2.00 | |
| 12.84 | 160 | −33.1 | 1.67 | |

* Very high values which are limited by resistance impedance of the inductor and the capacitance.

The first column on the left shows values of inductance L in an increasing order. The next column shows percentage of reactance X_{L} in respect to X_{C}. The third column from the left shows the current value that flows through branch 28 in respect of each pair of X_{L} and X_{C}. The fourth column shows the ratio between the current value through branch 28 and a reference current value where X_{L} is set to 0% of X_{C}. In the example the reference current I_{(X}_{_{L}}_{/X}_{_{C}}₌₀₎ value is equal to 19.8 Amp. The simulation result shows that as the inductor reactance value nears the capacitor reactance VIG rises.
The embodiments of the invention described for delivering VCG to electrical networks are also applicable for delivering VIG to such networks, for absorbing reactive power such as capacitors. One example of using VIG may be in situations wherein the network voltage is higher than the network nominal voltage which may occur as a result of power compensation delivered to the network by capacitors banks. In such a case when VIG is delivered to the power network the network voltage decreases.

### Benefits of the Present Invention

The circuitry of the present invention can deliver reactive power compensation to electrical networks of either low or high voltage with a low or high different type of faults. The circuitry can be installed in any place along the route of the electric power transmission which is generated by the power generator. For example, it may be installed along some point in the grid network or near reactive power consumers which use the inductive properties of an alternating electromagnetic field, i.e. mostly motors and transformers.

The present invention provides a practical solution to overcome the major limitation of switched capacitor based reactive compensation systems. By using the VCG concept the circuitry, in accordance with the present invention, particularly enables the supply of the required reactive current under low and very low network voltage conditions during a grid fault or grid drop without the need for sizable capacitors banks.

One example of a benefit of the present invention is in the option of use of renewable energy, particularly wind energy. Wind energy has to be integrated into a grid structure, grid operation, power plant dispatching process, reactive power balancing, voltage regulations and protection schemes. Existing art requires using an enormous amount of capacitors in order to provide the required reactive current even on low voltage conditions. A large amount of capacitors making entire solution too bulky and unsuitable for limited spaces along with significant price increase involved. The present invention provides a solution to enables the supply of the required reactive current under low and very low network voltage conditions during a grid fault.

1. Compensation circuitry for providing reactive power, comprising:
an inductance means;
a capacitor means and,
wherein said inductance means and said capacitor means are connected serially, thereby bringing said circuitry to a virtual gain selected from a group consisting of virtual inductance gain (VIG) or virtual capacitance gain (VCG), and wherein the virtual gain selected from said group is above the absolute value of 1.5.

2. A compensation circuitry for providing reactive power as in claim 1, wherein said inductance means is variable.

3. A compensation circuitry for providing reactive power as in claim 1, wherein said circuitry further comprises:
a switching means for said circuit and
a controller means, and
wherein said controller means is used to monitor the parameters of a power grid network while making the logical decision of when to turn said switching means on/off, for respectively connecting/disconnecting said inductance means serially with said capacitor means thereby bringing said circuitry to a capacitance reactance and increasing its virtual capacity gain (VCG).

4. A compensation circuitry for providing reactive power as in claim 3 wherein said switching means consists of silicon controlled rectifiers (SCRs).

5. A compensation circuitry for providing reactive power as in claim 3 wherein said circuitry is connected to grid of the electric power transmission which is generated by a power generator of said power grid.

6. A compensation circuitry for providing reactive power as in claim 3 wherein said controller means comprises hysteresis means for eliminating false switching.

7. A compensation circuitry for providing reactive power as in claim 3, wherein said controller means is used to monitor the parameters of a power grid network while applying a decision rule as to when to turn said switching means on/off, for respectively connecting/disconnecting said inductance means serially with said capacitor means thereby bringing said circuitry to an inductance reactance and increasing its virtual inductance gain (VIG).
